(19) United States
(12) Patent Application Publication
(10) Pub. No.: US 2010/0160561 A1
(43) Pub. Date: Jun. 24, 2010

(54) COPOLYMERS OF ALPHA-OLEFIN TYPE MONOMERS AND CURABLE FILM-FORMING COMPOSITIONS CONTAINING THEM

(75) Inventors: Simion Coca, Pittsburgh, PA (US); Edward R. Coleridge, Lower Burrell, PA (US); Gregory J. McCollum, Gibsonia, PA (US); James B. O'Dwyer, Wilmington, NC (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/343,565

(22) Filed: Dec. 24, 2008

(51) Int. Cl. C08F 220/06; C08L 75/00

(52) U.S. Cl. 525/123; 526/318.6

(57) ABSTRACT

The present invention is directed to copolymers, which are polymerization products of:
(i) a monomer having alpha-olefinic functionality;
(ii) a monomer different from (i) having active hydrogen functionality; and
(iii) a monomer different from (ii) having acrylic functionality.

The molar ratio of the monomer (i) having alpha-olefinic functionality to the monomer (iii) having acrylic functionality is less than 1:1, and the conversion of the monomer (i) having alpha-olefinic functionality during polymerization is greater than 90%. When monomers having methacrylic functionality are used to prepare the copolymer, the molar ratio of the monomer (iii) having acrylic functionality to the monomers having methacrylic functionality is greater than 2:1. Also disclosed are curable film-forming compositions comprising the copolymers.

### FIELD OF THE INVENTION

The present invention relates generally to copolymers of vinyl monomers and curable film-forming compositions that contain them. More specifically, the present invention is directed to functional copolymers derived from alpha-olefin type monomers and curable film-forming compositions that contain them.

### BACKGROUND OF THE INVENTION

Automotive manufacturers have very strict performance requirements of the coatings that are used in original equipment manufacture. For example, automotive OEM clear top coats are typically required to have a combination of good exterior durability, acid etch and water spot resistance, and excellent gloss and appearance.

Functional polymers used in coating compositions are typically random copolymers that include functional group-containing acrylic and/or methacrylic monomers. Such a functional copolymer will contain a mixture of polymer molecules having varying individual functional equivalent weights and polymer chain structures. In such a copolymer, the functional groups are located randomly along the polymer chain. In addition, the number of functional groups is not divided equally among the polymer molecules, such that some polymer molecules may actually be non-functional.

In a thermosetting composition, the formation of a crosslinked network is dependent on the functional equivalent weight as well as the architecture of the individual polymer molecules that comprise the composition. Polymer molecules having little or no reactive functionality (or having functional groups that are unlikely to participate in crosslinking reactions due to their locations along the polymer chain) will contribute little or nothing to the formation of the crosslinked network, resulting in decreased crosslink density and often compromising physical properties of the finally formed thermoset coating.

Few examples of alpha-olefin type monomer-containing copolymers in coating compositions can be found in the prior art. This is most likely due to the generally competitive nature of α-olefins with methacrylic monomers for reaction with acrylic monomers. It is extremely difficult to prepare copolymers having significant amounts of both α-olefins and methacrylic monomers.

Copolymer compositions that contain Lewis acids and/or transition metals intermingled with the copolymer can have a number of drawbacks when used commercially in coating compositions. First, some Lewis acids and transition metals are toxic and have adverse environmental effects if they are leached from the copolymer and enter the environment. Second, in coating applications the Lewis acids and transition metals may lead to poor color stability when the coating is exposed to UV light or simply cause the coating to discolor through other reactions or interactions. Further, the Lewis acids and transition metals may react with other ingredients in a coating formulation resulting in undesired properties, such as a shortened shelf-life for a given coating formulation.

It would be desirable to develop thermosetting compositions that comprise functional copolymers having a well-defined polymer chain structure. In particular, alternating copolymers containing alpha-olefin type monomers that are substantially free of Lewis acids and transition metals would be desirable. Such compositions would be expected to have a combination of favorable performance properties particularly in coatings applications, such as enhanced acid etch resistance in outdoor exposure tests.

### SUMMARY OF THE INVENTION

In accordance with the present invention, copolymers are provided which are polymerization products of:
(i) a monomer having alpha-olefinic functionality;
(ii) a monomer different from (i) having active hydrogen functionality; and
(iii) a monomer different from (ii) having acrylic functionality.

The molar ratio of the monomer (i) having alpha-olefinic functionality to the monomer (iii) having acrylic functionality is less than 1:1, and the conversion of the monomer (i) having alpha-olefinic functionality during polymerization is greater than 90%. When monomers having methacrylic functionality are used to prepare the copolymer, the molar ratio of the monomer (iii) having acrylic functionality to the monomers having methacrylic functionality is greater than 2:1. Also provided are curable film-forming compositions comprising the copolymers and curing agents that are reactive with the active hydrogen functionality.

### DETAILED DESCRIPTION OF THE INVENTION

It is noted that, as used in this specification and the appended claims, the singular forms “a,” “an,” and “the” include plural referents unless expressly and unequivocally limited to one referent. For example, while reference is made herein, including in the claims, to “a” polymeric binder, “a” monomer having structure I, “a” monomer having aromatic functionality, “an” ethylenically unsaturated monomer, “an” aminoplast curing agent, and the like, mixtures of any of these or other components can be used.

Other than in the operating examples, or where otherwise indicated, all numbers or expressions referring to quantities of ingredients, reaction conditions, etc., used in the specification and claims are to be understood as modified in all instances by the term “about”. Various numerical ranges are disclosed in this patent application. Because these ranges are continuous, they include every value between the minimum and maximum values. Unless expressly indicated otherwise, the various numerical ranges specified in this application are approximations.

The various embodiments and examples of the present invention as presented herein are each understood to be non-limiting with respect to the scope of the invention.

As used herein, the term “copolymer composition” is meant to include a synthesized copolymer as well as residues from initiators, catalysts, and other elements attendant to the synthesis of the copolymer, but not covalently incorporated therein. Such residues and other elements considered as part of the copolymer composition are typically mixed or co-mingled with the copolymer such that they incidentally tend to remain with the copolymer when it is transferred between vessels or between solvent or dispersion media.

As used herein, the term “substantially free” is meant to indicate that a material is present in trace amounts or as an incidental impurity. In other words, the material is not intentionally added to an indicated composition, but, for example, may be present at minor or inconsequential levels because it was carried over as an impurity as part of an intended composition component.

By “functional group” or “functionality” is meant combinations of elements present in a molecule that by their structure impart specific properties to the molecule. The functional groups may be chemically reactive functional groups or non-reactive functional groups. Non-limiting examples of reactive functional groups include epoxide and active hydrogen functionality such as primary amine, secondary amine, primary hydroxyl, secondary hydroxyl, carbamate, acid, such as carboxylic acid, amide, and anhydride. Non-limiting examples of non-reactive groups include olefinic groups, acrylic groups, methacrylic groups, and sterically hindered cyclic groups.

The present invention is directed to a copolymer composition. The copolymer is typically a polymerization product of:
(i) a monomer having alpha-olefinic functionality;
(ii) a monomer different from (i) having active hydrogen functionality; and
(iii) a monomer different from (ii) having acrylic functionality.

The molar ratio of the monomer (i) having alpha-olefinic functionality to the monomer (iii) having acrylic functionality is less than 1:1, and the conversion of the monomer (i) having alpha-olefinic functionality during polymerization is greater than 90%. Moreover, when monomers having methacrylic functionality are used to prepare the copolymer, the molar ratio of the monomer (iii) having acrylic functionality to monomers having methacrylic functionality is greater than 2:1.

The α-olefins suitable for use as the monomer (i) having alpha-olefinic functionality typically contain from 3 to 24, in some cases 4 to 18, and in other cases 4 to 12 linear, branched, or cyclic alkyl carbon atoms. Examples of α-olefins include undecylenic acid, 1-butene, 1-pentene, 3-methyl-1-butene, 1-hexene, 4-methyl-1-pentene, 3-methyl-1-pentene, 3-ethyl-1-pentene, 4,4-dimethyl-1-pentene, 4-methyl-1-hexene, 4-ethyl-1-hexene, 3-ethyl-1-hexene, 1-octene, 1-decene, 1-dodecene, 1-tetradecene, 1-hexadecene, and 1-octadecene. Mixtures of α-olefins may be used. The amount of the monomer (i) used to prepare the copolymer of the present invention is typically greater than 20 mole percent, or greater than 27 mole percent, or greater than 30 mole percent.

Active hydrogen functionality in the monomer (ii) may comprise, for example, primary amine, secondary amine, primary hydroxyl, secondary hydroxyl, carbamate, acid, including carboxylic acid, amide, and/or anhydride groups. Combinations of different monomers having the same or different types of active hydrogen functional groups may be used. Suitable ethylenically unsaturated monomers (ii) having active hydrogen functional groups include any of those known in the art. Examples of suitable monomers (ii) having active hydrogen functionality include hydroxypropyl acrylate, hydroxyethyl acrylate, 4-hydroxybutyl acrylate, and/or acrylic acid. Methacrylic functional monomers that contain active hydrogen groups may also be used. Examples include hydroxyethyl methacrylate, hydroxypropyl methacrylate, methacrylic acid/anhydride, and the like. However, it is noted again that when monomers having methacrylic functionality are used to prepare the copolymer, the molar ratio of the monomer (iii) having acrylic functionality to the monomers having methacrylic functionality is greater than 2:1.

Ethylenically unsaturated monomers (ii) containing secondary hydroxyl groups may comprise hydroxypropyl(meth)acrylate (i. e., acrylate or methacrylate) and/or similar secondary hydroxyalkyl(meth)acrylate monomers. Beta-hydroxy ester functional monomers can be prepared from ethylenically unsaturated, epoxy functional monomers and carboxylic acids having from 13 to 20 carbon atoms or amines having from 13 to 20 carbon atoms, or from ethylenically unsaturated acid- or amine-functional monomers and epoxy compounds containing at least 5 carbon atoms and which are not addition polymerizable.

Useful ethylenically unsaturated, epoxy functional monomers used to prepare the beta-hydroxy ester functional monomers include, but are not limited to, glycidyl acrylate, glycidyl methacrylate, allyl glycidyl ether, methallyl glycidyl ether, 1:1 (molar) adducts of ethylenically unsaturated monoisocyanates with hydroxy functional monoepoxides such as glycidol, and glycidyl esters of polymerizable polycarboxylic acids such as maleic acid. Glycidyl acrylate and glycidyl methacrylate are used most often. Examples of carboxylic acids include, but are not limited to, saturated monocarboxylic acids such as isostearic acid and aromatic unsaturated carboxylic acids. Examples of amines include 1° and 2° amines commonly known in the art such as methylethylamine, dimethyl amine, and the like.

Useful ethylenically unsaturated acid functional monomers used to prepare the beta-hydroxy ester functional monomers include monocarboxylic acids such as acrylic acid, methacrylic acid, crotonic acid; dicarboxylic acids such as itaconic acid, maleic acid and fumaric acid; and monoesters of dicarboxylic acids such as monobutyl maleate and monobutyl itaconate. The ethylenically unsaturated acid- or amine-functional monomer and epoxy compound are typically reacted in a 1:1 equivalent ratio. The epoxy compound does not contain ethylenic unsaturation that would participate in free radical-initiated polymerization with the unsaturated acid functional monomer. Useful epoxy compounds include 1,2-pentene oxide, styrene oxide and glycidyl esters or ethers, often containing from 8 to 30 carbon atoms, such as butyl glycidyl ether, octyl glycidyl ether, phenyl glycidyl ether and para-(tertiary butyl) phenyl glycidyl ether. Commonly used glycidyl esters include those of the structure:

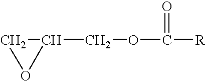

where R is a hydrocarbon radical containing from 4 to 26 carbon atoms. Often, R is a branched hydrocarbon group having from 8 to 10 carbon atoms, such as neopentanoate, neoheptanoate or neodecanoate. Suitable glycidyl esters of carboxylic acids include VERSATIC ACID 911 and CARDURA E, each of which is commercially available from Shell Chemical Co.

The amount of monomer (ii) having active hydrogen functionality used to prepare the copolymer composition is at least 7 molar percent, in some cases at least 17 molar percent, or typically at least 20 molar percent. The amount of monomer (ii) having active hydrogen functionality used to prepare the copolymer composition is no more than 27 molar percent, in some cases no more than 20 molar percent.

The monomer (iii) having acrylic functionality may comprise any acrylic monomers known in the art, and may be a mixture of different monomers. The monomer may contain functional groups, including active hydrogen functional groups, provided the monomer is different from the monomer (ii) having active hydrogen functionality. Examples of other suitable acrylic functional monomers include, but are not limited to, hydroxyethyl acrylate, hydroxypropyl acrylate, 4-hydroxybutyl acrylate, acrylic acid, methyl acrylate, ethyl acrylate, butyl acrylate, isobutyl acrylate, isobornyl acrylate, dimethylaminoethyl acrylate, acrylamide, perfluoro methyl ethyl acrylate, perfluoro ethyl ethyl acrylate, perfluoro butyl ethyl acrylate, trifluoromethyl benzyl acrylate, perfluoro alkyl ethyl, acryloxyalkyl terminated polydimethylsiloxane, acryloxyalkyl tris(trimethylsiloxy silane), and acryloxyalkyl trimethylsiloxy terminated polyethylene oxide, chlorotrifluoro ethylene, glycidyl acrylate, 2-ethylhexyl acrylate, and n-butoxy methyl acrylamide.

The amount of the monomer (iii) used to prepare the copolymer of the present invention is typically greater than 25 mole percent.

In certain embodiments of the present invention, in order to enhance the conversion of the α-olefin during copolymerization by minimizing competition between the α-olefin and any methacrylic functional monomers for reaction with the other ethylenically unsaturated monomers, the total moles of monomers having methacrylic functionality used to prepare the copolymer is less than the total moles of α-olefin monomer (i) used to prepare the copolymer. For similar reasons, the total amount of monomers having methacrylic functionality used to prepare the copolymer is typically less than 15 molar percent, based on the total moles of monomers used to prepare the copolymer. Ideally, the copolymer is substantially free of methacrylic functional monomer segments. The copolymer is also typically substantially free of maleic anhydride monomer segments, maleate ester monomer segments, fumaric acid monomer segments, and fumarate ester monomer segments. These types of multifunctional monomers can provide too many functional groups to the copolymer. This can be undesirable, for example, in coatings where a thermosetting composition may have a short shelf-life due to the overly functional nature of the copolymer.

Further, in certain embodiments, the copolymer composition of the present invention is substantially free of transition metals and Lewis acids, which have been used in the art to make alternating copolymers of mild donor monomers and mild acceptor monomers. The present invention does not need to use transition metal or Lewis acid adjuncts in preparing the copolymer composition; therefore, they do not need to be removed after polymerization and the resulting copolymer compositions will not suffer the drawbacks that may be observed with those copolymers that contain transition metals or Lewis acids.

The copolymer composition of the present invention can be prepared by any method known in the art, such as a method including the steps of (a) providing a monomer composition comprising one or more monomers (i); (b) mixing an ethylenically unsaturated monomer composition comprising monomers (ii) and (iii) with (a) to form a total monomer composition substantially free of maleic anhydride, fumaric acid, maleate- and fumarate-type monomers; and (c) polymerizing the total monomer composition in the presence of a free radical initiator in the substantial absence of transition metals and Lewis acids.

Any suitable free radical initiator may be used in the making of the copolymer. Examples of suitable free radical initiators include, but are not limited to, thermal free radical initiators, photo-initiators, and redox initiators. Examples of suitable thermal free radical initiators include, but are not limited to, peroxide compounds, azo compounds, and persulfate compounds.

Examples of suitable peroxide compound initiators include, but are not limited to, hydrogen peroxide, methyl ethyl ketone peroxides, benzoyl peroxides, di-t-butyl peroxide, di-t-amyl peroxide, dicumyl peroxide, diacyl peroxides, decanoyl peroxides, lauroyl peroxides, peroxydicarbonates, peroxyesters, dialkyl peroxides, hydroperoxides, peroxyketals, and mixtures thereof.

Examples of suitable azo compounds include, but are not limited to, 4-4′-azobis(4-cyanovaleric acid), 1-1′-azobiscyclohexanecarbonitrile), 2-2′-azobisisobutyronitrile, 2-2′-azobis(2-methylpropionamidine) dihydrochloride, 2-2′-azobis(2-methylbutyronitrile), 2-2′-azobis(propionitrile), 2-2′-azobis(2,4-dimethylvaleronitrile), 2-2′-azobis(valeronitrile), 2,2′-azobis[2-methyl-N-(2-hydroxyethyl)propionamide], 4,4′-azobis(4-cyanopentanoic acid), 2,2′-azobis(N,N′-dimethyleneisobutyramidine), 2,2′-azobis(2-amidinopropane) dihydrochloride, 2,2′-azobis(N,N′-dimethyleneisobutyramidine) dihydrochloride, and 2-(carbamoylazo)-isobutyronitrile.

After mixing, or during addition and mixing, polymerization of the monomers takes place. The polymerization can be run at any suitable temperature. Suitable temperature for the present method may be ambient, at least 50° C., in many cases at least 60° C., typically at least 75° C., and, in some cases, at least 100° C. Suitable temperature for the present method may further be described as being not more than 300° C., in many cases not more than 275° C., typically not more than 250° C., and, in some cases, not more than 225° C. The temperature is typically high enough to encourage good reactivity from the monomers and initiators employed. However, the volatility of the monomers and corresponding partial pressures create a practical upper limit on temperature determined by the pressure rating of the reaction vessel. The polymerization temperature may vary in any range of values inclusive of those stated above.

The polymerization can be run at any suitable pressure. A suitable pressure for the present method may be ambient, at least 1 psi, in many cases at least 5 psi, typically at least 15 psi, and, in some cases, at least 20 psi. Suitable pressures for the present method may further be described as being not more than 200 psi, in many cases not more than 175 psi, typically not more than 150 psi, and, in some cases, not more than 125 psi. The pressure is typically high enough to maintain the monomers and initiators in a liquid phase. The pressures employed have a practical upper limit based on the pressure rating of the reaction vessel employed. The pressure during polymerization temperature may vary in any range of values inclusive of those stated above.

The resulting copolymer has a number average molecular weight of at least 250, in many cases at least 500, typically at least 1,000, and, in some cases, at least 2,000. The present copolymer may have a number average molecular weight of up to 1,000,000, in many cases up to 500,000, typically up to 100,000, and, in some cases, up to 50,000. Certain applications will require that the number average molecular weight of the present copolymer not exceed 30,000, in some cases not exceed 25,000, in other cases not exceed 20,000, and, in certain instances, not exceed 16,000. Often the number average molecular weight ranges between 1000 and 100,000. The molecular weight of the copolymer is selected based on the properties that are to be incorporated into the copolymer composition. The molecular weight of the copolymer may vary in any range of values inclusive of those stated above.

The polydispersity index (PDI) of the copolymer is usually less than 4, in many cases less than 3.5, typically less than 3.0, and, in some cases, less than 2.5. Most often it ranges between 1.7 and 1.9. As used herein and in the claims, “polydispersity index” is determined from the following equation: (weight average molecular weight (Mw)/number average molecular weight (Mn)). A monodisperse polymer has a PDI of 1.0. Further, as used herein, Mn and Mw are determined from gel permeation chromatography using polystyrene standards.

The copolymer composition described above may be used in curable film-forming compositions in accordance with the present invention. Curable film-forming compositions of the present invention comprise:

(a) a polymeric binder comprising the copolymer described above; and

(b) a curing agent having functional groups that are reactive with active hydrogen functionality.

The polymeric binder (a) is typically present in the film-forming composition of the present invention in an amount of at least 10 percent by weight, often at least 25 percent by weight, more often at least 40 percent by weight, based on the total weight of (a) and (b) in the film-forming composition. The polymeric binder (a) is typically present in the film-forming composition of the present invention in an amount of no more than 90 percent by weight, often no more than 80 percent by weight, more often no more than 75 percent by weight, based on the total resin weight of (a) and (b) in the film-forming composition.

The film-forming composition of the present invention further comprises (b) a curing agent having functional groups that are reactive with active hydrogen functionality. The curing agent may be selected from aminoplasts, polyisocyanates, including blocked isocyanates, polyepoxides, beta-hydroxyalkylamides, organometallic acid-functional materials, polyamines, polyamides and mixtures of any of the foregoing.

Useful aminoplasts can be obtained from the condensation reaction of formaldehyde with an amine or amide. Nonlimiting examples of amines or amides include melamine, urea and benzoguanamine.

Although condensation products obtained from the reaction of alcohols and formaldehyde with melamine, urea or benzoguanamine are most common, condensates with other amines or amides can be used. For example, aldehyde condensates of glycoluril, which yield a high melting crystalline product useful in powder coatings, can be used. Formaldehyde is the most commonly used aldehyde, but other aldehydes such as acetaldehyde, crotonaldehyde, and benzaldehyde can also be used.

The aminoplast can contain imino and methylol groups. In certain instances, at least a portion of the methylol groups can be etherified with an alcohol to modify the cure response. Any monohydric alcohol like methanol, ethanol, n-butyl alcohol, isobutanol, and hexanol can be employed for this purpose. Nonlimiting examples of suitable aminoplast resins are commercially available from Cytec Industries, Inc. under the trademark CYMEL® and from Solutia, Inc. under the trademark RESIMENE®. Particularly useful aminoplasts include CYMEL® 385 (suitable for water-based compositions), CYMEL® 1158 imino-functional melamine formaldehyde condensates, and CYMEL® 303.

Other curing agents suitable for use include polyisocyanate crosslinking agents. As used herein, the term “polyisocyanate” is intended to include blocked (or capped) polyisocyanates as well as unblocked polyisocyanates. The polyisocyanate can be aliphatic, aromatic, or a mixture thereof. Diisocyanates and higher polyisocyanates such as isocyanurates of diisocyanates can be used. Isocyanate prepolymers, for example reaction products of polyisocyanates with polyols also can be used. Mixtures of polyisocyanate crosslinking agents can be used.

The polyisocyanate which is utilized as a crosslinking agent can be prepared from a variety of isocyanate-containing materials. Examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used.

Isocyanate groups may be capped or uncapped as desired. If the polyisocyanate is to be blocked or capped, any suitable aliphatic, cycloaliphatic, or aromatic alkyl monoalcohol or phenolic compound known to those skilled in the art can be used as a capping agent for the polyisocyanate. Examples of suitable blocking agents include those materials which would unblock at elevated temperatures such as lower aliphatic alcohols including methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether. Other suitable capping agents include oximes such as methyl ethyl ketoxime, acetone oxime and cyclohexanone oxime, lactams such as epsilon-caprolactam, pyrazoles such as dimethyl pyrazole, and amines such as dibutyl amine.

Polyepoxides are suitable curing agents for polymers having carboxylic acid groups and/or amine groups. Examples of suitable polyepoxides include low molecular weight polyepoxides such as 3,4-epoxycyclohexylmethyl 3,4-epoxycyclohexanecarboxylate and bis(3,4-epoxy-6-methylcyclohexyl-methyl)adipate. Higher molecular weight polyepoxides, including the polyglycidyl ethers of polyhydric phenols and alcohols described below, are also suitable as crosslinking agents.

Beta-hydroxyalkylamides are suitable curing agents for polymers having carboxylic acid groups. The beta-hydroxyalkylamides can be depicted structurally as follows:

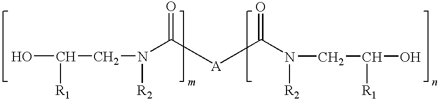

wherein R₁ is H or C1 to C5 alkyl; R₂ is H, C1 to C5 alkyl, or:

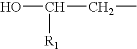

wherein R₁ is as described above; A is a bond or a polyvalent organic radical derived from a saturated, unsaturated, or aromatic hydrocarbon including substituted hydrocarbon radicals containing from 2 to 20 carbon atoms; m is equal to 1 or 2; n is equal to 0 or 2, and m+n is at least 2, usually within the range of from 2 up to and including 4. Most often, A is a C2 to C12 divalent alkylene radical.

Useful organometallic complexed materials which can be used as crosslinking agents include a stabilized ammonium zirconium carbonate solution commercially available from Magnesium Elektron, Inc. under the trademark BACOTE™ 20, stabilized ammonium, zirconium carbonate, and a zinc-based polymer crosslinking agent commercially available from Ultra Additives Incorporated under the trademark ZINPLEX 15.

Nonlimiting examples of suitable polyamine crosslinking agents include primary or secondary diamines or polyamines in which the radicals attached to the nitrogen atoms can be saturated or unsaturated, aliphatic, alicyclic, aromatic, aromatic-substituted-aliphatic, aliphatic-substituted-aromatic, and heterocyclic. Nonlimiting examples of suitable aliphatic and alicyclic diamines include 1,2-ethylene diamine, 1,2-propylene diamine, 1,8-octane diamine, isophorone diamine, propane-2,2-cyclohexyl amine, and the like. Nonlimiting examples of suitable aromatic diamines include phenylene diamines and toluene diamines, for example o-phenylene diamine and p-tolylene diamine. Polynuclear aromatic diamines such as 4,4′-biphenyl diamine, methylene dianiline and monochloromethylene dianiline are also suitable.

Appropriate mixtures of curing agents may also be used in the invention.

The curing agent (b) is typically present in the film-forming composition of the present invention in an amount of at least 10 percent by weight, often at least 25 percent by weight, more often at least 40 percent by weight, based on the total weight of (a) and (b) in the film-forming composition. The polymeric binder (a) is typically present in the film-forming composition of the present invention in an amount of no more than 90 percent by weight, often no more than 80 percent by weight, more often no more than 75 percent by weight, based on the total resin weight of (a) and (b) in the film-forming composition.

Optional ingredients such as, for example, plasticizers, surfactants, thixotropic agents, anti-gassing agents, anti-oxidants, colorants, UV light absorbers and similar additives conventional in the art may be included in the film-forming composition of the present invention. These ingredients are typically present at up to 40% by weight based on the total weight of resin solids.

The coatings of the present invention can also include a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by grinding or simple mixing. Colorants can be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference, and U.S. Provisional Application No. 60/482,167 filed Jun. 24, 2003, which is also incorporated herein by reference.

Example special effect compositions that may be used in the coating of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the coating of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, when used, the colorant is incorporated into the coating composition in amounts up to 80 percent by weight based on the total weight of coating solids. Metallic pigment may be employed in amounts of 0.5 to 25 percent by weight based on the total weight of coating solids.

The curable compositions described above can be applied to various substrates including but not limited to wood; metals including but not limited to ferrous substrates and aluminum substrates; glass; plastic, plastic and sheet molding compound-based plastics.

The compositions can be applied by conventional means including but not limited to brushing, dipping, flow coating, spraying, and the like, but they are most often applied by spraying. The usual spray techniques and equipment for air spraying, airless spray, and electrostatic spraying employing manual and/or automatic methods can be used.

Upon application to a substrate, the composition is allowed to coalesce to form a substantially continuous film on the substrate. Typically, the dry film thickness will be 0.01 to 5 mils (0.254 to 127 microns), such as 0.1 to 2 mils (2.54 to 50.8 microns) in thickness. The film is formed on the surface of the substrate by driving water and any coalescing solvents out of the film by heating or by an air drying period. The heating may be for only a short period of time, sufficient to ensure that any subsequently applied coatings can be applied to the film without dissolving the composition and/or causing other issues. Suitable drying conditions will depend on the particular composition but, in general, a drying time of from 1 to 5 minutes at a temperature of 68-250° F. (20-121° C.) will be adequate. More than one coat of the composition may be applied to develop the optimum appearance. Between coats, the previously applied coat may be flashed, that is, exposed to ambient conditions for 1 to 20 minutes.

The coalesced curable composition is next cured, typically by the application of heat. As used herein, including in the claims, by “cured” is meant a crosslink network is formed by covalent bond formation, e.g., between the functional groups of the aminoplast curing agent and the hydroxy groups of the polymer. The temperature at which the composition of the present invention cures is variable and depends in part on the type and amount of catalyst used. Typically, the composition has a cure temperature within the range of 130° C. to 160° C., such as from 140° C. to 150° C.

In accordance with the present invention, there is further provided a multi-component composite coating composition that includes a base coat deposited from a pigmented film-forming composition; and a transparent top coat applied over the base coat. Either the base coat or the transparent top coat or both coats may include the curable film-forming composition described above. The multi-component composite coating composition as described herein is commonly referred to as a color-plus-clear coating composition.

The pigmented film-forming composition from which the base coat is deposited can be the film-forming composition of the present invention or any other compositions useful in coatings applications, particularly automotive applications in which color-plus-clear coating compositions are extensively used. Pigmented film-forming compositions conventionally comprise a resinous binder and a colorant, such as one or more of those described above. Particularly useful resinous binders are acrylic polymers, polyesters including alkyds, polyurethanes, and the copolymer composition of the present invention.

For example, the resinous binders for the pigmented film-forming base coat composition can be organic solvent-based materials, such as those described in U.S. Pat. No. 4,220,679, note column 2, line 24 through column 4, line 40, incorporated herein by reference. Also, water-based coating compositions such as those described in U.S. Pat. Nos. 4,403,003, 4,147,679, and 5,071,904, incorporated herein by reference, can be used as the binder in the present pigmented film-forming composition.

Ingredients that may be optionally present in the pigmented film-forming base coat composition are those which are well known in the art of formulating surface coatings and include but are not limited to surfactants, flow control agents, thixotropic agents, fillers, anti-gassing agents, organic co-solvents, catalysts, and other customary auxiliaries. Examples of these optional materials and suitable amounts are described in U.S. Pat. Nos. 4,220,679, 4,403,003, 4,147,769, and 5,071,904.

The pigmented film-forming base coat compositions of the present invention can be applied to any of the substrates described above by any conventional coating techniques such as those described above, but are most often applied by spraying. The usual spray techniques and equipment for air spraying, airless spray, and electrostatic spraying employing either manual or automatic methods can be used. The pigmented film-forming composition can be applied in an amount sufficient to provide a base coat having a dry film thickness of 0.1 to 5 mils (2.5 to 125 microns), such as 0.1 to 2 mils (2.5 to 50 microns).

After deposition of the pigmented film-forming base coat composition onto the substrate, and prior to application of the transparent top coat, the base coat can be cured or alternatively dried. In drying the deposited base coat, at least some of the organic solvent and/or water is driven out of the base coat film by heating or the passage of air over its surface. Suitable drying conditions will depend on the particular base coat composition used and/or on the ambient humidity in the case of certain water-based compositions. In general, drying of the deposited base coat is performed over a period of from 1 to 15 minutes and at a temperature of 21° C. to 93° C.

The transparent top coat can be applied over the deposited base coat by any of the methods by which coatings are known to be applied. In an embodiment of the present invention, the transparent top coat is applied by electrostatic spray application. When the transparent top coat is applied over a deposited base coat that has been dried but not cured, the two coatings can be co-cured to form the multi-component composite coating composition of the present invention. Both the base coat and top coat can be heated together to conjointly cure the two layers. Typically, curing conditions of 130° C. to 160° C. for a period of 20 to 30 minutes are employed. The transparent top coat typically has a dry film thickness within the range of 0.5 to 6 mils (13 to 150 microns), e.g., from 1 to 3 mils (25 to 75 microns). Alternative curing methods and conditions/parameters can be used if desired.

The present invention is more particularly described in the following examples, which are intended to be illustrative only, since numerous modifications and variations therein will be apparent to those skilled in the art. Unless otherwise specified, all parts and percentages are by weight.

### EXAMPLE 1

This example demonstrates the preparation of 1-Octene/hydroxypropyl acrylate/butyl acrylate copolymer

| | | Parts by weight |
|---|---|---|
| | Ingredients | (grams) |
| Charge 1 | 1-Octene | 150.00 |
| | DOWANOL PMA¹ | 150.00 |
| Charge 2 | Hydroxypropyl acrylate | 120.00 |
| | Butyl acrylate | 330.00 |
| Charge 3 | Di-t-amyl peroxide | 12.00 |

¹Available from available from Dow Chemical Co

Charge 1 was added to a 1-liter stirred stainless steel pressure reactor and heated to 220° C. The agitation on the reactor was set at 500 rpm. Charges 2 and 3 were added to stirred stainless steel pressure reactor over 20 min. During the monomers and initiator addition the temperature was maintained 220° C. and at 100-140 PSI. The reactor was then cooled to 50° C. and the resin was drained. The final solids content of the resulting resin was determined to be 86% determined at 110° C. for one hour. The resin had number average molecular weight, Mₙ=1550, M_{w}=3090 and polydispersity M_{w}/Mₙ=2.0, M_{z}=5360 (determined by gel permeation chromatography using polystyrene as a standard). The hydroxyl value was 73, corresponding to 100% conversion of 1-octene.

### EXAMPLE 2

This example demonstrates the preparation of 1-Hexene/hydroxypropyl acrylate/butyl acrylate copolymer.

| | | Parts by weight |
|---|---|---|
| | Ingredients | (grams) |
| Charge 1 | 1-Hexene | 150.00 |
| | DOWANOL PMA | 150.00 |
| Charge 2 | Hydroxypropyl acrylate | 120.00 |
| | Butyl acrylate | 330.00 |
| Charge 3 | Di-t-amyl peroxide | 12.00 |

Charge 1 was added to a 1-liter stirred stainless steel pressure reactor and heated to 220° C. The agitation on the reactor was set at 500 rpm. Charges 2 and 3 were added to the stirred stainless steel pressure reactor over 20 min. During the monomers and initiator addition the temperature was maintained 220° C. and at 140-290 PSI. The reactor was then cooled to 50° C. and the resin was drained. The final solids content of the resulting resin was determined to be 83% determined at 110° C. for one hour. The resin had number average molecular weight, Mₙ=1470, M_{w}=2870 and polydispersity M_{w}/Mₙ=2.0, M_{z}=4940 (determined by gel permeation chromatography using polystyrene as a standard). The hydroxyl value was 71, corresponding to 100% conversion of 1-hexene.

### EXAMPLE 3

This example demonstrates the preparation of 1-butene/hydroxyethyl acrylate/hydroxypropyl acrylate/butyl acrylate.

| | | Parts by weight |
|---|---|---|
| | Ingredients | (grams) |
| Charge 1 | Isobutylene | 400.00 |
| Charge 2 | Di-t-amyl peroxide | 11.40 |
| Charge 3 | Hydroxypropyl Acrylate | 480.00 |
| | 2-Hydroxyethyl acrylate | 480.00 |
| | Butyl acrylate | 240.00 |

Charge 1 was added to a 300 cc stirred stainless steel pressure reactor at 400 g/hour. Charges 2 and 3 were pumped simultaneously to the 300 cc stirred stainless steel pressure reactor at 11.40 g/hour and 1200 g/hour, respectively. The agitation on the reactor was set at 500 rpm and the reactor temperature was adjusted to 225° C. During the monomer addition the temperature was maintained 225° C. at a pressure of 400-600 PSI. The final solids content of the resulting resin was determined to be 99.6% at 110° C. for one hour. The resin had number average molecular weight, Mₙ=1980, M_{w}=5580 and polydispersity M_{w}/Mₙ=2.8, M_{z}=15180 (determined by gel permeation chromatography using polystyrene as a standard). The hydroxyl number was 267, corresponding to 99% conversion of 1-butene.

### Preparation of Coating Compositions

### EXAMPLE 4

This example demonstrates coating compositions prepared using the resin from Example 1 cured with melamine or isocyanate.

A coating composition was prepared by combining 4 grams of 1-octene/hydroxypropyl acrylate/butyl acrylate copolymer of Example 1 with 2 grams of aminoplast (CYMEL 303, available from Cytec Industries), 2.3 g of butyl acetate, and 0.01 gram of dodecylbenzene sulfonic as catalyst. The mixture was drawn down at a thickness of 3 mil (22.9 microns) over steel panel primed with electrocoat primer. The drawn down coating layer was baked for 30 minutes at 140° C. The resulting cured film was hard and passed solvent resistance tests of 100 double rubs with acetone.

A coating composition was prepared by combining 5 grams of 1-octene/hydroxypropyl acrylate/butyl acrylate copolymer of Example 1 with 1.41 grams of DESMODUR N3390 (polyisocyanate available from BAYER USA), 3 g of butyl acetate, and 0.01 gram of dibutyltindilaurate as catalyst. The mixture was drawn down at a thickness of 3 mil (22.9 microns) over steel panel primed with electrocoat primer. The drawn down coating layer was baked for 30 minutes at 140° C. The resulting cured film was hard and passed solvent resistance tests of 100 double rubs with acetone.

### EXAMPLE 5

This example demonstrates coating compositions prepared using the resin from Example 2 cured with melamine or isocyanate.

A coating composition was prepared by combining 4 grams of 1-hexene/hydroxypropyl acrylate/butyl acrylate copolymer of Example 2 with 2 grams of CYMEL 303, 2.3 g of butyl acetate, and 0.01 gram of dodecylbenzene sulfonic as catalyst. The mixture was drawn down at a thickness of 3 mil (22.9 microns) over steel panel primed with electrocoat primer. The drawn down coating layer was baked for 30 minutes at 140° C. The resulting cured film was hard and passed solvent resistance tests of 100 double rubs with acetone.

A coating composition was prepared by combining 5 grams of 1-hexene/hydroxypropyl acrylate/butyl acrylate copolymer of example 2 with 1.37 grams of DESMODUR N3390, 3 g of butyl acetate, and 0.01 gram of dibutyltindilaurate as catalyst. The mixture was drawn down at a thickness of 3 mil (22.9 microns) over steel panel primed with electrocoat primer. The drawn down coating layer was baked for 30 minutes at 140° C. The resulting cured film was hard and passed solvent resistance tests of 100 double rubs with acetone.

### EXAMPLE 6

This example demonstrates coating compositions prepared using the resin from Example 3 cured with melamine or isocyanate.

A coating composition was prepared by combining 4 grams of 1-butene/hydroxypropyl acrylate/hydroxyethyl acrylate/butyl acrylate copolymer of example 3 with 2.2 grams of CYMEL 303, 3 g of butyl acetate, and 0.01 gram of dodecylbenzene sulfonic as catalyst. The mixture was drawn down at a thickness of 3 mil (22.9 microns) over steel panel primed with electrocoat primer. The drawn down coating layer was baked for 30 minutes at 140° C. The resulting cured film was hard and passed solvent resistance tests of 100 double rubs with acetone.

A coating composition was prepared by combining 5 grams of 1-butene/hydroxypropyl acrylate/hydroxyethyl acrylate/butyl acrylate copolymer of example 3 with 5.14 grams of DESMODUR N3390, 3 g of butyl acetate, and 0.01 gram of dibutyltindilaurate as catalyst. The mixture was drawn down at a thickness of 3 mil (22.9 microns) over steel panel primed with electrocoat primer. The drawn down coating layer was baked for 30 minutes at 140° C. The resulting cured film was hard and passed solvent resistance tests of 100 double rubs with acetone.

The present invention has been described with reference to specific details of particular embodiments thereof. It is not intended that such details be regarded as limitations upon the scope of the invention except insofar as and to the extent that they are included in the accompanying claims.

We claim:

1. A copolymer, said copolymer being a polymerization product of:
(i) a monomer having alpha-olefinic functionality;
(ii) a monomer different from (i) having active hydrogen functionality; and
(iii) a monomer different from (ii) having acrylic functionality;
wherein the molar ratio of the monomer (i) having alpha-olefinic functionality to the monomer (iii) having acrylic functionality is less than 1:1, and the conversion of the monomer (i) having alpha-olefinic functionality during polymerization is greater than 90%, and wherein when monomers having methacrylic functionality are used to prepare the copolymer, the molar ratio of the monomer (iii) having acrylic functionality to the monomers having methacrylic functionality is greater than 2:1.

2. The copolymer of claim 1, wherein the monomer (i) comprises undecylenic acid, 1-butene, 1-pentene, 3-methyl-1-butene, 1-hexene, 4-methyl-1-pentene, 3-methyl-1-pentene, 3-ethyl-1-pentene, 4,4-dimethyl-1-pentene, 4-methyl-1-hexene, 4-ethyl-1-hexene, 3-ethyl-1-hexene, 1-octene, 1-decene, 1-dodecene, 1-tetradecene, 1-hexadecene, and/or 1-octadecene.

3. The copolymer of claim 1, wherein the active hydrogen functionality comprises primary amine, secondary amine, primary hydroxyl, secondary hydroxyl, carbamate, acid, including carboxylic acid, amide, and/or anhydride.

4. The copolymer of claim 1, wherein the monomer (ii) comprises hydroxypropyl acrylate, hydroxyethyl acrylate, 4-hydroxybutyl acrylate, and/or acrylic acid.

5. The copolymer of claim 1, wherein the monomer (ii) comprises a reaction product of an ethylenically unsaturated, epoxy functional monomer and a carboxylic acid having from 13 to 20 carbon atoms or primary amine having from 13 to 20 carbon atoms, or an ethylenically unsaturated acid- or amine-functional monomer and an epoxy compound which is not addition polymerizable containing at least 5 carbon atoms.

6. The copolymer of claim 1, wherein the amount of the monomer (i) used to prepare the copolymer is greater than 30 molar percent, based on the total moles of monomers used to prepare the copolymer.

7. The copolymer of claim 1, wherein the amount of the monomer (iii) used to prepare the copolymer is greater than 25 molar percent, based on the total moles of monomers used to prepare the copolymer.

8. The copolymer of claim 1, wherein the total moles of monomers having methacrylic functionality used to prepare the copolymer is less than the total moles of monomer (i) used to prepare the copolymer.

9. The copolymer of claim 1, wherein the total amount of monomers having methacrylic functionality used to prepare the copolymer is less than 15 molar percent, based on the total moles of monomers used to prepare the copolymer.

10. The copolymer of claim 9, wherein the copolymer is substantially free of methacrylic functional monomer segments, maleic anhydride monomer segments, maleate ester monomer segments, fumaric acid monomer segments, and fumarate ester monomer segments.

11. A curable film-forming composition comprising:
(a) a polymeric binder comprising a copolymer, said copolymer being a polymerization product of:
(i) a monomer having alpha-olefinic functionality;
(ii) a monomer different from (i) having active hydrogen functionality; and
(iii) a monomer different from (ii) having acrylic functionality;
wherein the molar ratio of the monomer (i) having alpha-olefinic functionality to the monomer (iii) having acrylic functionality is less than 1:1, and the conversion of the monomer (i) having alpha-olefinic functionality during polymerization is greater than 90%, and wherein when monomers having methacrylic functionality are used to prepare the copolymer, the molar ratio of the monomer (iii) having acrylic functionality to the monomers having methacrylic functionality is greater than 2:1; and
(b) a curing agent having functional groups that are reactive with active hydrogen functionality.

12. The film-forming composition of claim 11, wherein the monomer (i) comprises undecylenic acid, 1-butene, 1-pentene, 3-methyl-1-butene, 1-hexene, 4-methyl-1-pentene, 3-methyl-1-pentene, 3-ethyl-1-pentene, 4,4-dimethyl-1-pentene, 4-methyl-1-hexene, 4-ethyl-1-hexene, 3-ethyl-1-hexene, 1-octene, 1-decene, 1-dodecene, 1-tetradecene, 1-hexadecene, and/or 1-octadecene.

13. The film-forming composition of claim 11, wherein the active hydrogen functionality comprises primary amine, secondary amine, primary hydroxyl, secondary hydroxyl, carbamate, acid, including carboxylic acid, amide, and/or an hydride.

14. The film-forming composition of claim 11, wherein the monomer (ii) comprises hydroxypropyl acrylate, hydroxyethyl acrylate, 4-hydroxybutyl acrylate, and/or acrylic acid.

15. The film-forming composition of claim 11, wherein the monomer (ii) comprises a reaction product of an ethylenically unsaturated, epoxy functional monomer and a carboxylic acid having from 13 to 20 carbon atoms or primary amine having from 13 to 20 carbon atoms, or an ethylenically unsaturated acid- or amine-functional monomer and an epoxy compound which is not addition polymerizable containing at least 5 carbon atoms.

16. The film-forming composition of claim 11, wherein the amount of the monomer (i) used to prepare the copolymer is greater than 30 molar percent, based on the total moles of monomers used to prepare the copolymer.

17. The film-forming composition of claim 11, wherein the amount of the monomer (iii) used to prepare the copolymer is greater than 25 molar percent, based on the total moles of monomers used to prepare the copolymer.

18. The film-forming composition of claim 11, wherein the total moles of monomers having methacrylic functionality used to prepare the copolymer is less than the total moles of monomer (i) used to prepare the copolymer.

19. The film-forming composition of claim 11, wherein the total amount of monomers having methacrylic functionality used to prepare the copolymer is less than 15 molar percent, based on the total moles of monomers used to prepare the copolymer.

20. The film-forming composition of claim 19, wherein the copolymer is substantially free of methacrylic functional monomer segments, maleic anhydride monomer segments, maleate ester monomer segments, fumaric acid monomer segments, and fumarate ester monomer segments.

21. The film-forming composition of claim 11, wherein the curing agent (b) comprises an aminoplast and/or a polyisocyanate.
